(19) United States
(12) Patent Application Publication
(10) Pub. No.: US 2006/0288078 A1
(43) Pub. Date: Dec. 21, 2006

(54) Communication terminal and server access method

(75) Inventor: Tetsuya Mashimo, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/387,075

(22) Filed: Mar. 21, 2006

(30) Foreign Application Priority Data
Jun. 15, 2005 (JP) 2005-175337

(51) Int. Cl. G06F 15/16

(52) U.S. Cl. 709/206; 709/228

(57) ABSTRACT

A communication terminal includes an address specifying unit specifying an address, the address is to access the server, a parameter determining unit determining whether or not the address specified by the address specifying unit is attached with a specific parameter, a display unit displaying a warning screen if the parameter determining unit determines that the specific parameter is attached, and a control unit accessing the server based on the address specified by the address specifying unit.

### CROSS-REFERENCE TO RELATED APPLICATIONS

This application is based upon and claims the benefit of priority from prior Japanese Patent Application No. 2005-175337, filed Jun. 15, 2005, the entire contents of which are incorporated herein by reference.

### BACKGROUND OF THE INVENTION

1. Field of the Invention

The present invention relates to communication terminals such as a fixed telephone, mobile phone and personal digital assistant (PDA). In particular, the present invention relates to a communication terminal, which can access a web server, and to a server access method.

2. Description of the Related Art

In recent years, it is general to access a web site via the Internet using a communication terminal such as a mobile phone to acquire various kinds of information.

In order to access the web site, the following methods are employed in general. One is a method of using a web browser, and inputting the address (uniform resource locator [URL]) of the target site using alphanumerics and symbols. Another is a method of using services called a search engine, and inputting search equation combining various keywords to find the target site.

The mobile phone is limited in its number of keys; for example, three letters are allocated to one key. For this reason, there is a problem that it is very troublesome for the user to input the foregoing URL, and time is taken.

Conventionally, there has been proposed an access method, which can readily access a web site even if a communication terminal such as mobile phone having limited keys is used (e.g., see JPN. PAT. APPLN. KOKAI Publication No. 2002-91846). According to the access method, a server is previously registered with the relationship between a home page address (URL) and a digit sequence. When the digit sequence is transmitted from a user, the server searches for a URL corresponding to the digit sequence, and thereafter, returns it to the user. Then, the user accesses the home page using the URL transmitted from the server. By doing so, the user inputs the digit sequence only without inputting the URL, thereby accessing a desired home page.

Recently, a URL is transmitted to a user using electronic mail (referred to as e-mail, hereinafter) in order to obtain the users accessing to a web site. The foregoing e-mail includes a so-called junk mail, which is transmitted to many unspecified the users using address information generated at random. A mail system of the mobile phone can transmit e-mail using a phone number as address information in addition to an e-mail address. Therefore, the junk mail sender combines digits at random to generate phone numbers, and-thereafter, transmits e-mail to unspecified the users using the generated phone numbers as address information.

The URL described in the e-mail is attached with inherent parameter (e.g., expressed by character string) corresponding to individual address information. Then, access to a web site is made using the URL attached with the parameter. In this case, the parameter is inherent to address information; therefore, the web site can transmit a web page displaying address information corresponding to the parameter, for example, a user's phone number. The web page can make the user browse a sentence claiming a site charge on which the user inherently has no need to pay, together with address information.

In other words, the user has recognition of acquiring personal information (address information), and thereby, the user feels crisis situation.

Therefore, even if the user does not actually use charged services provided by the site, the user is dismayed at the content displayed on the foregoing web page. For this reason, there exists the case where the user pays the site available charge.

Thus, if access is once made using the URL including parameter attached for specifying the user (address information), the following problem arises. Specifically, the server determines that the address information is valid from the parameter attached to the URL. As a result, mail claiming an access charge is transmitted in succession.

Usually, when accessing a web site, the user is not conscious of character string expressing the parameter attached to the URL. For this reason, the user carelessly accesses a page claiming the foregoing illegal site available charge using the URL acquired via e-mail.

### BRIEF SUMMARY OF THE INVENTION

An object of the present invention is to provide a communication terminal, which can prevent the user from carelessly making access using address having parameter attached for specifying the user, and to provide a server access method.

According to an embodiment of the present invention, there is provided a communication terminal for accessing a server, comprising:

an address specifying unit configured to specify an address, the address is to access the server;

a parameter determining unit configured to determine whether or not the address specified by the address specifying unit is attached with a specific parameter;

a display unit configured to display a warning screen if the parameter determining unit determines that the specific parameter is attached; and

a control unit configured to access the server based on the address specified by the address specifying unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing the system in which a mobile phone (communication terminal) according to an embodiment of the present invention is used;

FIGS. 2A and 2B are each views showing a parameter corresponding table managed in a server according to an embodiment of the present invention;

FIG. 3 is a block diagram showing the circuit configuration of a mobile phone according to an embodiment of the present invention;

FIG. 4 is a flowchart to explain the operation of a mobile phone in a first embodiment;

FIG. 5 is a view showing a display screen in the mobile phone of the first embodiment;

FIG. 6 is a flowchart to explain the control data setup procedure in a second embodiment;

FIGS. 7A, 7B and 7C are views showing a display screen in a mobile phone of the second embodiment;

FIG. 8 is a view showing access control data set up by the control data setup procedure in the second embodiment; and

FIG. 9 is a flowchart to explain the operation of a mobile phone in the second embodiment.

### DETAILED DESCRIPTION OF THE INVENTION

Embodiments of the present invention will be described below with reference to the accompanying drawings.

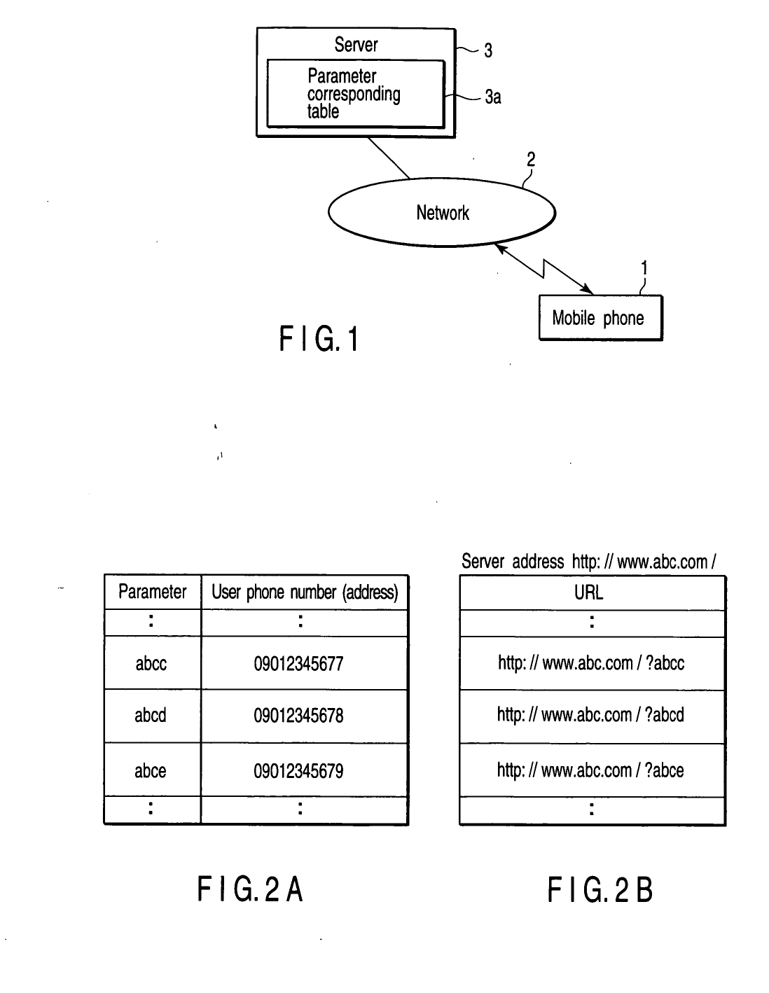

FIG. 1 is a block diagram schematically showing the system in which a mobile phone 1 (communication terminal) according to an embodiment of the present invention is used.

According to the system shown in FIG. 1, the mobile phone 1 can access a server 3 via a network 2.

The network 2 includes Internet Protocol (IP) network and access network for accessing the IP network. The following networks are given as the access network. One is mobile communication networks such as PDC (Personal Digital Cellular) network and IMT 2000 (International Mobile Telecommunication 2000) network. Another is Personal Handyphone System (PHS) network and wireless LAN.

In this embodiment, a mail system (not shown) managing e-mail transmission/reception via the mobile phone 1 transmits e-mail to the phone number of the mobile phone 1 in addition to e-mail address.

The server 3 shown in FIG. 1 transmits e-mail describing address (URL) for accessing the server 3 to unspecified many the users according to address information generated at random. The server 3 generates phone numbers as address information for e-mail transmission destination. Simultaneously, the server 3 generates individual parameters corresponding to the phone numbers, and stores them in a parameter corresponding table 3a.

FIG. 2A shows one example of the parameter corresponding table 3a managed in the server 3.

The parameter corresponding table 3a shown in FIG. 2A is stored with the parameter “abcc” corresponding to a phone number “09012345677” generated as e-mail address information. Likewise, the parameter corresponding table 3a is stored with a parameter “abcd” corresponding to a phone number “09012345678” and a parameter “abce” corresponding to a phone number “09012345679”.

The server 3 generates a URL described in the mail text of the e-mail based on the parameters stored in the parameter corresponding table 3a. FIG. 2B shows URLs created correspondingly to parameters. For example, if the parameter “abcc” is given, the server 3 attaches the parameter to the URL “http://www.abc.com” of the server 3 (web site) to generate a URL “http://www.abc.com/?abcc”, as seen from FIG. 2B. The symbol “?” shown in the URL is a specific character expressing that the character corresponding to the parameter follows.

When being accessed from the URL “http://www.abc.com/?abcc”, the server 3 determines that access is made from the mobile phone having the phone number “09012345677” corresponding to the parameter “abcc”.

In FIG. 1, in order to simplify the explanation, e-mail describing a URL is transmitted from the server 3, and thereafter, the server 3 is accessed via the URL described in the e-mail. However, in this case, the server transmitting e-mail describing a URL and the server accessed via the URL described in the e-mail may be configured independently from each other.

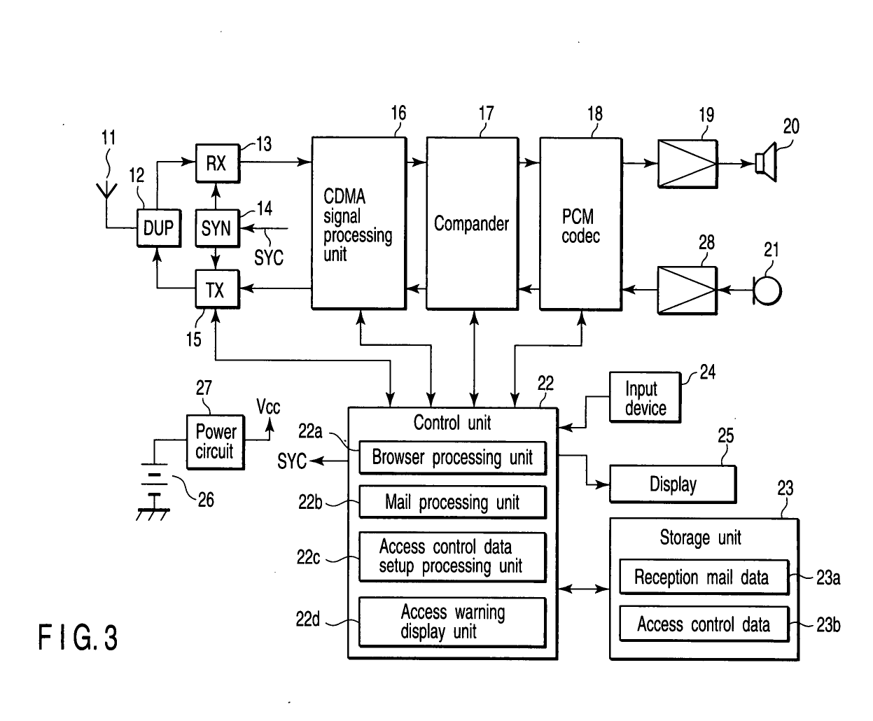

FIG. 3 is a block diagram showing the circuit configuration of a mobile phone according to an embodiment.

In FIG. 3, a radio signal transmitted from a base station (not shown) is received by an antenna 11, and thereafter, input to a receiver circuit (RX) 13 via an antenna duplexer (DUP) 12. The receiver circuit 13 mixes the received radio signal with a local oscillation signal output from a frequency synthesizer (SYN) 14 to down-convert it into an intermediate frequency signal. Then, the receiver circuit 13 orthogonally demodulates the down-converted intermediate frequency signal to output a reception baseband signal. In this case, the local oscillation signal frequency generated from the frequency synthesizer 14 is set according to a control signal SYC output from a control unit 22.

The reception base band signal is input to a Code Division Multiple Access (CDMA) signal processing unit 16. The CDMA signal processing unit 16 includes a RAKE receiver. The RAKE receiver back-spreads several paths contained in the reception baseband signal using spread codes. The signals having back-diffused paths are arbitrated, and thereafter, synthesized. In this manner, reception packet data having a predetermined transmission format is obtained. The reception packet data is input to a compression/decompression processing unit (referred to as compander, hereinafter) 17.

The compander 17 separates the reception packet data output from the CDMA signal processing unit 16 every media using a multiplex separation unit. Then, the compander 17 decodes the data separated every media. For example, if the reception packet data contains audio data, a speech codec decodes the audio data. Moreover, if the reception packet data contains video data, a video codec decodes the video data.

A digital audio signal obtained according to decoding is supplied to a PCM coding unit 18 (referred to as PCM codec, hereinafter). The PCM codec 18 PCM-decodes the digital audio signal output from the compander 17 to output an analog audio signal. The analog audio signal is amplified by a receive amplifier 19, and thereafter, output from a speaker 20.

The digital video signal decoded by the video codec of the compander 17 is input to a control unit 22. The control unit 22 displays the digital video signal output from the compander 17 on a display 25 via a video RAM. The display 25 comprises a Liquid Crystal Device (LCD). Incidentally, the control unit 22 displays video data captured (picked-up) by a camera (not shown) via the video RAM in addition to the received video data.

If the reception packet data is e-mail, the compander 17 outputs the e-mail to the control unit 22. The control unit 22 stores the e-mail in a storage unit 23 (reception mail data 23a). An input device 24 reads the reception mail data 23a stored in the storage unit 23 to display it on the display 25 in accordance with a display operation by the user. In the display 25, information to show a device operation mode, information to notify a call, information to show the residual level of a battery 26 and charge state, and clock to show the present time are displayed.

On the other hand, a voice signal of a talker input to a microphone 21 is amplified to a proper level by a speech amplifier 28. Thereafter, the voice signal is subjected to PCM coding by the PCM codec 18, and then, input to the compander 17 after being converted into a digital audio signal. Moreover, a video signal output from the camera (not shown) is digitized via the control unit 22, and thereafter, input to the compander 17. An e-mail created in the control unit is input from the control unit 22 to the compander 17.

The compander 17 detects input voice energy from the digital audio signal output from the PCM codec 18, and based on the detection result, determines a transmission date rate. The compander 17 codes the digital audio signal into a signal having a format corresponding to the transmission data rate, thereby generating audio data. Moreover, the compander 17 codes the digital video signal output from the control unit 22 to generate video data. The compander 17 multiplexes the foregoing audio and video data according to a predetermined transmission format using a multiplex separation unit to generate transmission packet data. Then, the compander 17 outputs the transmission packet data to the CDMA signal processing unit 16. Incidentally, if an e-mail is output from the control unit 22, the compander 17 converts the e-mail into packet data.

The CDMA signal processing unit 16 carries out spectrum spread processing with respect to the transmission packet data output from the compander 17 using spread codes allocated to transmission channels. Thereafter, the CDMA signal processing unit 16 outputs the output signal to the transmitter circuit 15. The transmitter circuit 15 modulates the spectrum-spread signal using digital modulation such as Quadrature Phase Shift Keying (QPSK). The transmitter circuit 15 further synthesizes a transmission signal generated by the modulation and the local oscillation signal generated from the frequency synthesizer 14, and then, converts it into a radio signal frequency. The transmitter circuit 15 amplifies the radio signal to high frequency so that the radio signal becomes a transmission power level instructed by the control unit 22. The radio signal thus amplified is supplied to the antenna 11 via the antenna duplexer 12, and thereafter, transmitted to a base station from the antenna 11.

The input device 24 is provided with dial keys (character keys) and several function keys. The function keys include transmission key, end key, power key, volume control key, mode designation key and cursor key. The power circuit 27 generates a predetermined operating power supply voltage Vcc using the output of a battery 26 as a source, and then, supplies it to various circuits. In this case, the battery 26 is chargeable via a charger circuit (not shown).

The mobile phone 1 includes a storage unit 23. The storage unit 23 uses an Electrically erasable and Programmable ROM (EEPROM) or hard disk as a storage medium. For example, the storage unit 23 is stored with reception mail data 23a and access control data 23b.

The reception mail data 23a is stored with received e-mails and their reception history data. The reception mail data 23a is arbitrarily readable and displayable.

The access control data 23b is data for controlling a warning display with respect to access using a URL included in the reception data 23a. The access control data 23b is set in accordance with the user's instruction via a control data setting procedure described later (second embodiment).

The control unit 22 includes a microcomputer (Central Processing Unit [CPU]), for example. The control unit 22 has the following various processing functions according to the present invention. The functions are browser processing unit 22a, mail processing unit 22b, access control data setup processing unit 22c and access warning display unit 22d. The foregoing processing units 22a to 22d are realized by which the microcomputer executes programs corresponding to these units.

The browser processing unit 22a access a web server specified by URL via the network 2 (Internet), and downloads various data from the web server, and thereafter, displays them.

The mail processing unit 22b executes various processing related to e-mail; for example, creates, receives and transmits e-mail, stores received e-mail data and displays stored e-mail. If a URL is described in the mail text of the e-mail, the mail processing unit 22b allows the user to specify the URL as an access address on a display screen. If the URL is specified in the mail text, the mail processing unit 22b requests the browser processing unit 22a to access a web server (web site) shown by the specified URL.

When the browser processing unit 22a accesses the web server (web site) shown by the specified URL, the mail processing unit 22b displays a web page screen (web startup).

The access control data setup processing unit 22c sets access control data for controlling whether or not a warning screen should be displayed, if a URL attached with a parameter is described in the mail text of the e-mail (second embodiment). The access control data setup processing unit 22c inputs instruction from the user, and sets access control data via a control data setup screen.

If the user specifies the URL in the mail text of the e-mail displayed by the mail processing unit 22b, the access warning display unit 22d determines whether or not the specified address is attached with a specific parameter. If it is determined that the URL is attached with a specific parameter, the access warning display unit 22d displays a warning screen. In other words, the notification is given to the user.

That is, there is a possibility that the parameter attached to the address specified as an access destination is a parameter attached for specifying the user. If access control data is set by the access control data setup processing unit 22c, the access warning display unit 22d controls the display of the warning screen in accordance with the access control data.

### First Embodiment

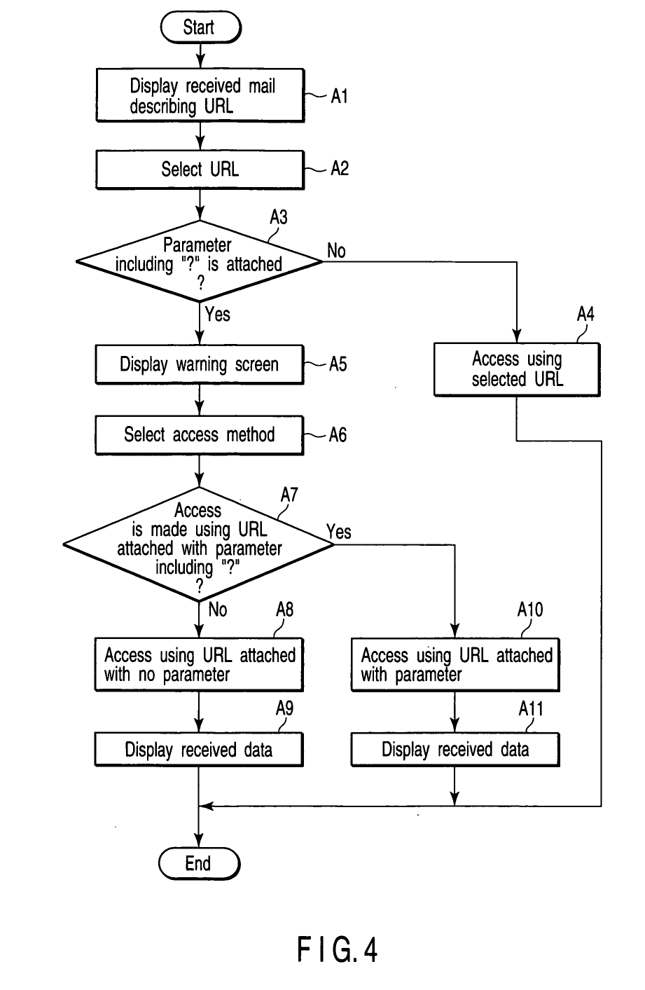

The operation of the mobile phone of the first embodiment will be explained below with reference to a flowchart shown in FIG. 4.

In this case, the phone number of the mobile phone 1 is set as “09012345678”. The server 3 generates a phone number as an e-mail transmission destination (address information), and generates a parameter corresponding to each phone number. The server 3 stores the phone number associating with the parameter corresponding table 3a shown in FIG. 2A. The parameter corresponding table 3a includes the phone number of the mobile phone 1, that is, “09012345678” and parameter “abcd” corresponding to the phone number.

As seen from FIG. 2B, the server 3 attaches a parameter corresponding to the phone number to the URL “http://www.abc.com” of the server 3 every phone number stored in the parameter corresponding table 3a. By doing so, the server 3 generates a URL described in the mail text of e-mail. The server 3 transmits an e-mail describing a URL attached with the parameter to the corresponding phone number. Incidentally, when attaching the parameter, specific character “?” is attached to the portion before the parameter.

When receiving an e-mail from the server 3, the mobile phone 1 stores the received e-mail in the storage unit 23 as reception mail data 23a. A URL “http://www.abc.com/?abcd” attached with the parameter “abcd” individually generated by the server 3 is described in the mail text of the e-mail received from the server 3.

When the user makes instructions to display the received e-mail using the input device 24, the mail processing unit 22b reads the reception mail data 23a stored in the storage unit 23, and thereafter, displays it on the display 25 (step A1).

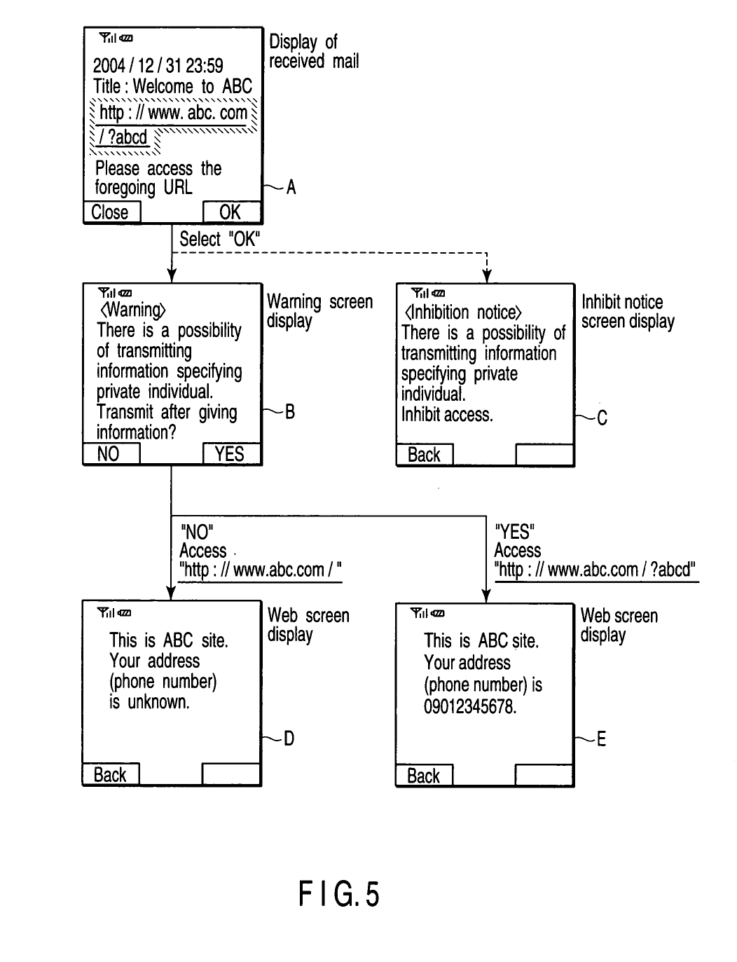

“A” of FIG. 5 shows a screen example in which the mail text of the received e-mail is displayed. On a screen A shown in FIG. 5, the following descriptions are displayed. One is a message recommending the user to access the server 3 (site), that is, “Please access URL”. Another is the URL showing the access destination, that is, “http://www.abc.com/?abcd”. When the user moves a cursor to the URL described in the displayed mail text using the input device 24, the mail processing unit 22b displays the URL in the display form such as reversing display different from others.

In other words, this implies that the user makes a select operation on the display screen, and thereby, web startup is possible.

Here, the user can arbitrary select “Close” for finishing the e-mail display or “OK” for instructing to execute web startup using predetermined keys of the input device.

If an operation of selecting “OK” is made (step A2), the unit 22b determines whether or not the URL of the mail text is attached with a parameter including “?” (step A3). In other words, the access warning display unit 22b searches the character “?” from the character string corresponding to the URL description format to determine whether or not a character exists following the character “?”.

If no parameter is attached to the URL, the browser processing unit 22a accesses the server 3 (web site) based on the URL described in the mail text. Then, the unit 22a downloads data of web page shown by the URL to display it on the display 25 (step A4). In other words, a normal web startup is made if no parameter is attached to the URL.

On the other hand, if a parameter is attached to the URL, the access warning display unit 22d displays a warning screen for warning the following matter on the display 25 (step A5). Specifically, if access is made to the web site using the URL specified in the e-mail text, there is a possibility that the private individual is specified.

“B” of FIG. 5 shows a warning screen example. On a warning screen “B” shown in FIG. 5, the following messages are displayed. One is a message for giving a warning to the user, that is, “There is a possibility of transmitting information specifying a private individual”. Another is a message recommending the user to select an access method using URL, that is, “Transmit after giving information?”

In this case, the user can arbitrarily select the following items using predetermined keys of the input device 24 (step A6). One is “NO” for making an access after deleting the parameter from the URL described in the e-mail. Another is “YES” for making an access using the URL attached with the parameter.

If the user selects “NO” (step A7, No), the browser processing unit 22a accesses the server 3 (web site) based on a URL obtained by deleting the character “?” and the parameter following there from the URL of the mail text. Then, the unit 22a downloads data of web page shown by the URL to display it on the display 25 (step A8).

“D” of FIG. 5 shows a screen example displayed when access is made using the URL deleting the parameter. If access is made using the URL deleting the parameter, the server 3 can not determine the accessing the user (phone number) based on the parameter corresponding table 3a. Therefore, as seen from a screen “D” of FIG. 5, the server 3 can not display the phone number expressing the accessing the user.

On the other hand, if the user selects “YES” (step A7, Yes), the unit 22a accesses the server 3 (web site) based on the URL described in the mail text (step A10). Then, the browser processing unit 22a downloads data of web page shown by the URL to display it on the display 25 (step A11).

“E” of FIG. 5 shows a screen example displayed when access is made using the URL attached with parameter, described in the mail text. If access is made using the URL attached with parameter, that is, “http://www.abc.com/?abcd”, the sever 3 can determine the phone number corresponding to the parameter from the parameter corresponding table 3a. Therefore, as depicted in a screen “E” of FIG. 5, the phone number expressing the accessing the user is displayed.

As described above, if the URL attached with parameter is described in the e-mail received by the mobile phone 1, access is made to the server 3 using the URL. In this case, warning display describing that there is a possibility that personal information is acquired is given to the user. Therefore, it is possible to prevent the user from carelessly making access using the URL attached with parameter. Since the warning screen is displayed, the user confirms URL showing access destination, and thereafter, can arbitrarily select any access method of making access using URL attached with parameter or URL deleting parameter.

### Second Embodiment

The operation of a mobile phone according to a second embodiment will be explained below.

According to the first embodiment, if access destination address is specified, the warning screen is always displayed so long as URL is attached with parameter. According to he second embodiment, the user previously sets up access control data, and thereby, it is possible to control whether or not the warning screen is displayed.

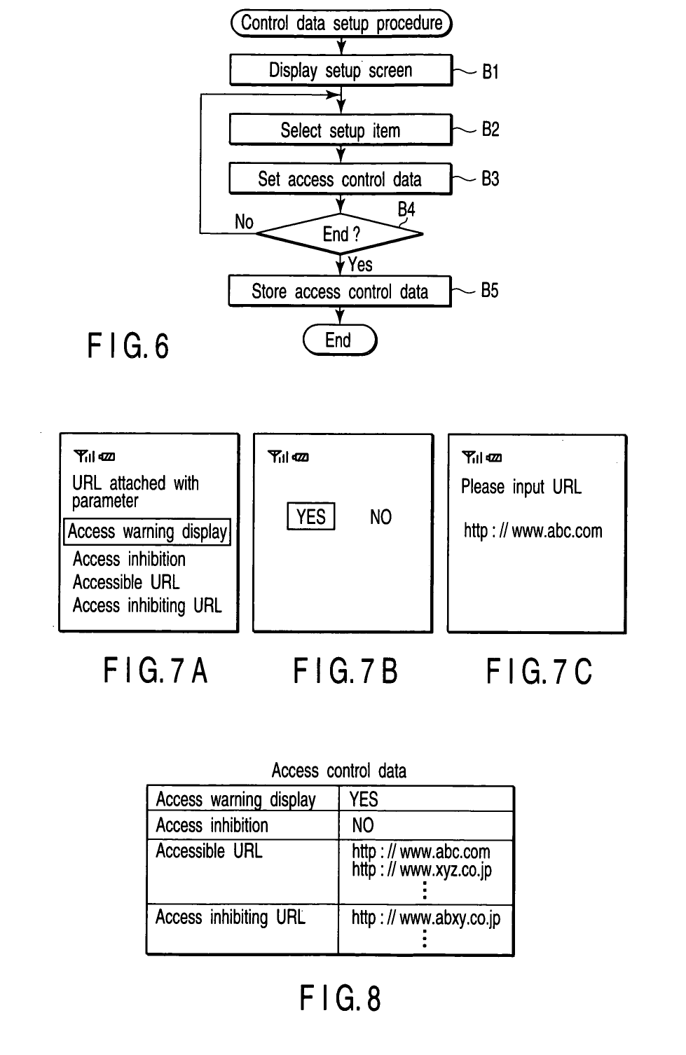

The control data setup procedure will be explained below with reference to a flowchart shown in FIG. 6. The control data setup procedure is taken to set up control data for controlling outputs such as warning screen display if URL attached with parameter is specified as an access address.

User inputs a request to execute the control data setup procedure using the input device 24. In response to the request, the access control data setup processing unit 22c displays a control data setup screen on the display 25 (step B1).

FIG. 7A shows a control data setup screen example. Several items are displayed on a control data setup screen shown in FIG. 7A. Specifically, “access warning display”, “access inhibition”, “accessible URL” and “access inhibiting URL” are given. User can arbitrarily specify any of the foregoing several items using the input device 24 (cursor key).

The “access warning display” is an item to set whether or not the access warning display unit 22d displays a warning screen when URL showing access destination is specified and the URL is attached with parameter.

The “access inhibition” is an item to set whether or not access is inhibited when URL showing access destination is specified and the URL is attached with parameter.

The “accessible URL” is an item to register accessible URL (address). If it is obvious that a server (web site) has no problem even if access is made using URL attached with parameter, the URL of the server (web site) is previously registered.

The “access inhibiting URL” is an item to register URL (address) inhibiting access. If the server (web site) has a problem when access is made using URL attached with parameter, the URL of the server (web site) is previously registered.

When the foregoing item “access warning display” is selected (step B2), the access control data setup processing unit 22c displays a screen for setting whether or not a warning screen is displayed as shown in FIG. 7B. Specifically, on the setup screen shown in FIG. 7B, the user can arbitrarily select any of “YES” when displaying a warning screen or “NO” when displaying no warning screen using the input device 24 (cursor key).

The access control data setup processing unit 22c stores setting contents specified in the setup screen in the storage unit 23 as address control data 23b (step B3).

Likewise, when the foregoing item “access inhibiting” is selected (step B2), the unit 22c displays a screen for setting whether or not an inhibit screen is displayed as shown in FIG. 7B. The access control data setup processing unit 22c stores setting contents specified in the setup screen in the storage unit 23 as address control data 23b (step B3).

When the foregoing item “accessible URL” is selected (step B2), the access control data setup processing unit 22c displays a URL input screen shown in FIG. 7C. Specifically, on the URL input screen shown in FIG. 7C, the user can arbitrarily input URL using dial keys (character keys) of the input device 24.

The unit 22c stores URL input on the URL input screen in the storage unit 23 as address control data 23b (step B3).

Likewise, when the foregoing item “access inhibiting URL” is selected (step B2), the unit 22c displays a URL input screen shown in FIG. 7C. The access control data setup processing unit 22c stores setting contents specified in the URL input screen in the storage unit 23 as address control data 23b (step B3).

FIG. 8 shows access control data 23b stored in the storage unit 23 via the foregoing control data setup procedure. Incidentally, if the item “access inhibiting” is set, setting relating to the item “access warning display” becomes invalid. Moreover, if items “accessible URL” and “access inhibiting URL” are set, several URLs are settable as seen from FIG. 8.

In the foregoing description, access control data is settable with respect to items shown in FIG. 7A; however, items other than above may be settable. For example, item “Do not always attach parameter” or “Always attach parameter” is settable without displaying the warning screen.

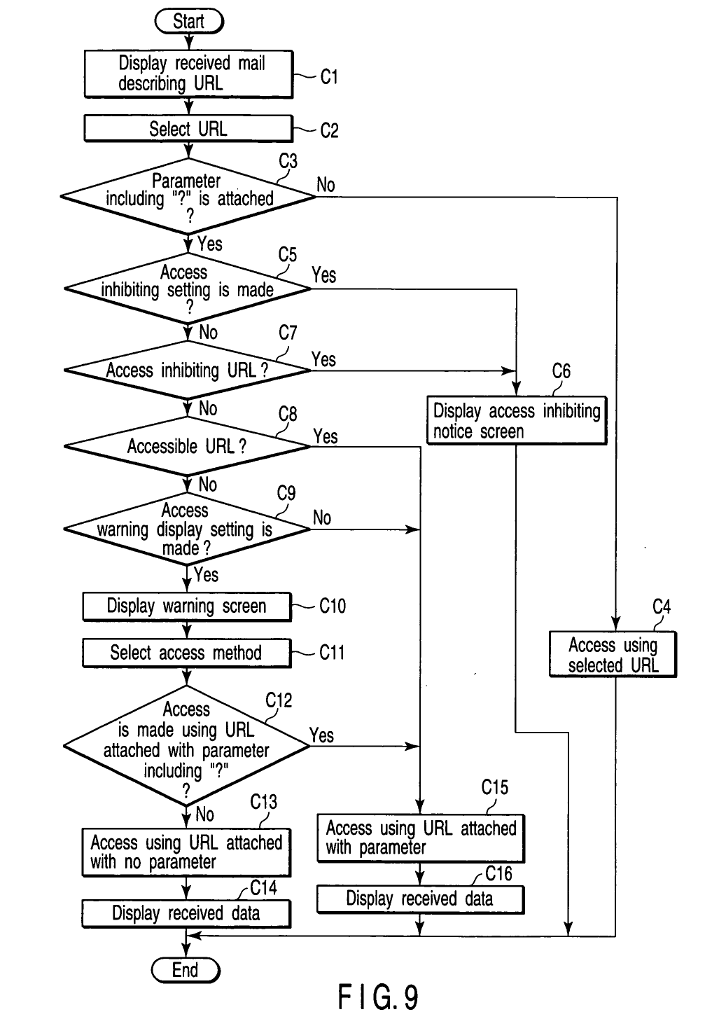

The access operation by the mobile phone 1 using URL described in e-mail in the second embodiment will be explained below with reference to a flowchart shown in FIG. 9.

In the flowchart shown in FIG. 9, steps C1 to C3 and steps C10 to C16 are the same procedure as steps A1 to A3 and steps A5 to A11 described in the flowchart shown in FIG. 4, respectively. Therefore, the details are omitted.

When URL described in the mail text is selected (step C2), the access warning display unit 22d determines whether or not the URL of the ml text is attached with a parameter including “?” (step C3).

If the parameter is not attached (step C3, Yes), the browser processing unit 22a accesses the server 3 (web site) based on the described in the mail text, and thereafter, downloads data of web page shown by the URL to display it on the display 25 (step C4).

On the other hand, the parameter is not attached (step C3, No), the unit 22d refers to the access control data 23b stored in the storage unit 23 to confirm whether or not access inhibiting setting is made (step C5).

If access inhibiting setting is made (step C5, Yes), the access warning display unit 22d displays an inhibit notice screen for notifying the user of inhibiting access using the specified URL on the display 25 (step C6).

“C” of FIG. 5 shows an inhibit notice screen example. On an inhibit notice screen “C” shown in FIG. 5, the following messages are displayed. One is a message for giving warning to the user, that is, “There is a possibility of transmitting information specifying private individual”. Another is a message for notifying the user that access using the specified URL should not be executed, that is, “Inhibit access”.

The foregoing “access inhibiting” is previously set, and thereby, it is possible to prevent the user from executing access using the URL attached with the parameter by an erroneous operation.

On the other hand, if access inhibiting setting is not made (step C5, No), the unit 22d makes the following determination. Specifically, the access warning display unit 22d determines whether or not the URL specified as,access destination is stored as access inhibiting URL in the access control data 23b stored in the storage unit 23. Incidentally, the access warning display unit 22d makes a comparison of URL using portion excluding parameter as a target.

If the URL is stored as access inhibiting URL (step C7, Yes), the access warning display unit 22d displays an inhibit notice screen (i.e., screen “C” of FIG. 5) for notifying the user of inhibiting access using the specified URL on the display 25 (step C6).

Specifically, even if access warning display setting is made, access inhibiting URL is previously set as being low reliability web site. Therefore, access is inhibited without access warning display. By doing so, it is possible to securely prevent the user from accessing undesirous web site using the URL attached with parameter.

On the other hand, if the URL is not stored as access inhibiting URL (step C7, No), the access warning display unit 22d refers to the access control data 23b stored in the storage unit 23 to determine whether or not the URL specified as access destination is stored as accessible URL. Incidentally, the access warning display unit 22d makes a comparison of URL using portion excluding parameter as a target.

If the URL is stored as accessible URL (step C8, Yes), the unit 22a accesses the server 3 (web site) based on the URL (step C15). Thereafter, the browser processing unit 22a downloads data of web page shown by the URL to display it on the display 25 (step C16).

Specifically, even if access warning display setting is made, accessible URL is previously set as being high reliability web site. Therefore, access is possible without access warning display. By doing so, the user's confirmation procedure by displaying the warning screen is omitted; therefore, the operability can be improved.

On the other hand, if the URL is not stored as accessible URL (step C8, No), the access warning display unit 22d refers to the access control data 23b stored in the storage unit 23 to confirm whether or not access warning display setting is made.

If access warning display setting is not made (step C9, No), the browser processing unit 22a accesses the server 3 (web site) based on the URL described in the mal text (step C15). Thereafter, the unit 22a downloads data of web page shown by the URL to display it on the display 25 (step C16).

On the other hand, if access warning display setting is made (step C9, Yes), the unit 22d displays the warning screen “B” shown in FIG. 5 on the display 25 (step C10). Specifically, the access warning display unit 22d displays the warning screen “B” for giving warning that there is a possibility of specifying private individual.

In the following, the same procedures as steps A6 to A11 of the flowchart shown in FIG. 5 are taken (steps C11 to C16).

According to the foregoing second embodiment, it is determined whether or not the access warning display is made if the URL specified as access destination is neither access inhibiting URL nor accessible URL. However, it may be previously determined whether or not the access warning display is made. In this case, if access warning display setting is made, the same procedure as described above is taken. Specifically, it is determined whether the URL specified as access destination is access inhibiting URL or accessible URL. Then, if the URL specified as access destination is access inhibiting URL or accessible URL, no access warning display is made.

By doing so, even if access warning display setting is made, the user's confirmation procedure by displaying the warning screen is omitted; therefore, the operability can be improved.

According to the second embodiment, the access control data 23b for controlling an execution of access using URL attached parameter is set, and thereby, the following advantages are obtained. Specifically, when accessing URL attached with described in an e-mail, a warning display to the user is made in accordance with the user's available condition of the mobile phone 1. Moreover, access using URL attached with parameter is inhibited; therefore, this serves to securely prevent the user from being specified by illegal web site.

In the foregoing embodiments, URL described in the e-mail received by the mobile phone 1 is given as an object. In this case, the present invention is applicable to an e-mail received by other information apparatuses, for example, personal computer and PDA.

In the foregoing embodiments, URL described in the mail text of the e-mail is given as an object; in this case, URL described in other texts may be given as an object. For example, address described in web page may be given as the object.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication terminal for accessing a server, comprising:
an address specifying unit configured to specify an address, the address is to access the server;
a parameter determining unit configured to determine whether or not the address specified by the address specifying unit is attached with a specific parameter;
a display unit configured to display a warning screen if the parameter determining unit determines that the specific parameter is attached; and
a control unit configured to access the server based on the address specified by the address specifying unit.

2. The communication terminal according to claim 1, wherein the address specifying unit specifies a URL (uniform resource locator) as an address.

3. The communication terminal according to claim 1, wherein the address specifying unit includes:
a mail data storage unit configured to store mail data including address received via an e-mail;
an address display unit configured to display address included in the mail data stored in the mail data storage unit; and
an address select unit configured to select address displayed by the address display unit.

4. The communication terminal according to claim 1, further comprising:
an address select unit configured to select whether or not access is made to the server based on a first address attached with a parameter determined by the parameter determining unit and a second address deleting the parameter when the display unit displays the warning screen,
the control unit accessing the server using the first or second address selected by the address select unit.

5. The communication terminal according to claim 1, further comprising:
a warning setup unit configured to set whether or not a warning screen is displayed via the display unit,
the display unit displaying the warning screen if setting for displaying the warning screen is made by the warning setup unit.

6. The communication terminal according to claim 1, further comprising:
an access inhibiting setup unit configured to set whether or not access using address determined that a parameter is attached by the parameter determining unit is inhibited,
wherein the control unit controls canceling access using the address specified by the address specifying unit if the parameter determining unit determines that the parameter is attached.

7. The communication terminal according to claim 1, further comprising:
an accessible address registering unit configured to register accessible address; and
an accessible address determining unit configured to determine whether or not an address specified by the address specifying unit is registered in the accessible address registering unit,
wherein the display unit makes no display of the warning screen if the accessible address determining unit determines that the address is registered in the accessible address registering unit.

8. The communication terminal according to claim 1, further comprising:
an access inhibiting address registering unit configured to register address inhibiting address; and
an access inhibiting address determining unit configured to determine whether or not an address specified by the address specifying unit is registered in the access inhibiting address registering unit,
wherein the control unit controls canceling access using the address specified by the address specifying unit if the access inhibiting address determining unit determines that the address is registered in the access inhibiting address registering unit.

9. A communication terminal comprising:
an access unit configured to access a web server;
a mail processing unit configured to receive an e-mail;
an address specifying unit configured to specify an address included in mail data of the e-mail received by the mail processing unit;
a parameter determining unit configured to determine whether or not the address specified by the address specifying unit is attached with a specific parameter;
a display unit configured to display a warning screen if the parameter determining unit determines that the specific parameter is attached;
an address select unit configured to select whether or not access is made to a web server based on a first address attached with a parameter determined by the parameter determining unit and a second address deleting the parameter when the display unit displays the warning screen; and
the control unit configured to access the web server using the first or second address selected by the address select unit.

10. The communication terminal according to claim 9, wherein the parameter determining unit determines that the parameter is attached if the address is attached with a specific character.

11. A server access method of accessing a server, comprising:
specifying an address showing an access destination server;
determining whether or not the specified address is attached with a specific parameter;
displaying a warning screen if it is determined that the specific parameter is attached;
selecting whether or not access is made to a web server based on a first address attached with the parameter and a second address deleting the parameter when the warning screen is displayed; and
accessing the web server based on the selected first or second address.

12. The method according to claim 11, further comprising:
displaying mail data including an address received via an e-mail; and
specifying the address from the displayed mail data.

13. The method according to claim 11, further comprising:
previously setting whether or not the warning screen is displayed; and
displaying the warning screen if setting for displaying the warning screen is made and it is determined that the specific parameter is attached.
